(19) United States
(12) Patent Application Publication
(10) Pub. No.: US 2011/0264592 A1
(43) Pub. Date: Oct. 27, 2011

(54) TEMPLATE-BASED TECHNIQUE FOR MAKING A BEST PRACTICES FRAMEWORK ACTIONABLE

(76) Inventors: Sven Graupner, Mountain View, CA (US); Hamid Reza Motahari Nezhad, Sunnyvale, CA (US); Sharad Singhal, Belmont, CA (US); Sujoy Basu, Sunnyvale, CA (US)

(21) Appl. No.: 12/768,178

(22) Filed: Apr. 27, 2010

(51) Int. Cl. G06Q 10/00; G06F 3/048; G06F 17/24; G06T 11/20

(52) U.S. Cl. 705/301; 705/348; 715/208; 715/760; 345/440

(57) ABSTRACT

A template-based technique for making a best practices framework actionable includes creating a formal representation of a best practices framework, where the representation includes a machine-readable template. A portion of the template is interpreted to link the portion of the template with logic that corresponds to an action. Execution of the logic is triggered to perform the action in response to occurrence of a trigger condition.

### BACKGROUND

Best practices frameworks are often produced by organizations to provide guidelines for performing various processes in various domains. Examples of domains include information technology management, software development, and so forth. Best practices frameworks are often described at a relatively high level, and often are in the form of documents (paper document and/or electronic documents) that provide the definitions of the best practices frameworks.

### BRIEF DESCRIPTION OF THE DRAWINGS

Some embodiments are described with respect to the following figures:

FIGS. 1 and 2 are flow diagrams of processes of a template-based technique to making a best practices framework actionable, according to some embodiments;

FIG. 3 is a knowledge graph of concepts and relationships among the concepts for use by a system according to some embodiments;

FIG. 4 is a schematic diagram of an architecture of a system according to some embodiments;

FIG. 5 is a block diagram of a computer system incorporating some embodiments.

### DETAILED DESCRIPTION

A best practices framework is a collection of established and documented techniques, processes, activities, and/or systems that are proven and more effective at delivering a target outcome than other techniques, processes, activities, and/or systems. Information relating to a best practices framework is often developed based on prior executions of tasks, with the information relating to the best practices framework developed over time based on repeated performances of the tasks. Best practices frameworks can be employed in various domains, including quality assurance, software development, information technology (IT) management, governance, risk management, or other domains.

Some examples of best practices frameworks are noted below. A Six Sigma framework (e.g., as described in Thomas Pyzdek, “The Six Sigma Handbook: A Complete Guide for Green Belts, Black Belts, and Managers at All Levels,” McGraw-Hill, 2001) or an ISO (International Organization for Standardization) 9000 framework (e.g., as described in R. W. Peach, “The ISO 9000 Handbook,” McGraw-Hill, 2003) is used for quality assurance. A balance score card framework (e.g., as described in Maris Martinsons et al., “The balanced scorecard: a foundation for the strategic management of information systems,” Decision Support Systems, pp 71-88, February 1999) is a framework for performance management using business metrics for decision making. Enterprise Architecture frameworks (e.g., as described in The Open Group, “The Open Group Architecture Framework (TOGAF),” http://www.opengroup.org/togaf/, or in ZIFA, “The Zachman Framework for Enterprise Architecture,” www.zifa.com) aim to link business functions to information technology (IT). A COBIT (Control Objectives for Information and Related Technology) framework (e.g., as described in ISACA, “The Control Objectives for Information and related Technology (COBIT),” www.isaca.org/cobit) is a best practices framework for IT governance. An IT Infrastructure Library (ITIL) framework (e.g., as described in Information Technology Infrastructure Library (ITIL), Version 3, 5, Volumes, http://www.itil-officialsite.com), eTOM (Enhanced Telecom Operations Map) framework (e.g., as described in TeleManagement Forum, “Enhanced Telecom Operations Map (eTOM)—The Business Process Framework,” http://www.tmforum.org/BestPracticesStandards/BusinessProcessFramework/1647/Home.html), or an ISO/IEC (International Organization for Standardization/International Electrotechnical Commission) 20000 (e.g., as described in Jenny Dugmore, “Achieving ISO/IEC 20000—The Differences Between BS 15000 and ISO/IEC 20000,” BSI Standards. ISBN 0580473481, 2006) is a best practices framework for IT service management.

Many best practices frameworks refer to processes as the main abstraction to define scoped work and how this work should be performed. However, since frameworks describe processes at a rather high level, the term “process” in these frameworks often refers to the scope of work (the “what”) rather than how this work is organized and performed. The latter has to be arranged by the organization that uses the framework causing ambiguity.

A common feature of best practices frameworks is that they summarize a large amount of experience gathered and refined over some period of time by domain experts, who define and describe the organization, structure and context of how work should be organized among people in a particular domain.

To improve organizational efficiency and repeatability of work in an enterprise (e.g., a company, an educational organization, a government agency, and so forth), it is desirable that best practices frameworks be followed by workers in their daily work. However, interactions between such workers are facilitated through conversations, collaboration and ad-hoc decision making. Traditional control-flow oriented process specifications are not appropriate to implement processes identified in best practices frameworks, especially in domains where high-skilled professionals work in contexts involving creativity and flexibility. Business processes, in their traditional definition, are rigid, and are not flexible and may not offer adequate support. Traditional processes do not adequately support interactions among people that are spontaneous, unforeseen and may not be followed in a strict order.

To bridge the gap between high level abstractions available in best practices frameworks and specific actions to be taken by individuals or organizations, to derive actionable tasks that can be automated, and/or to retain the flexibility of ad-hoc interactions among people while improving repeatability, a best practices support system according to some embodiments is provided.

In some implementations, the best practices support system supports process definitions from best practices frameworks in the form of templates that guide the overall organization of work. A template is a semi-structured construct, representing a best practices process, defined using a set of concepts and relationships taken from the best practices framework.

In some implementations, the best practices support system uses various concepts to model processes in a best practices framework. In addition, the best practices support system can support the creation of new templates using the concepts and can permit dynamic adjustments to existing templates.

In some implementations, the best practices support system provides workspaces through which conversations between individuals are mediated between people (or organizations) working together in the context of a business practices process. Workspaces are also used to share electronic work material such as documents.

The best practices support system can drive the interactions among people based on the templates, and can enable extension of the templates as part of normal interactions as workers carry out their tasks.

With the best practices support system, actionable tasks can be identified in best practices frameworks. Templates can be annotated with semantic information allowing them to be interpreted by the system, which can then be used for triggering actionable tasks. The triggered actionable tasks can be assigned to individuals (or organizations) to be performed by the individuals/organizations. In some implementations, the best practices support system uses an event-based mechanism to track the definition of tasks as well as their state of execution (progress). This enables flexible execution of activities that do not have to be in a fixed order.

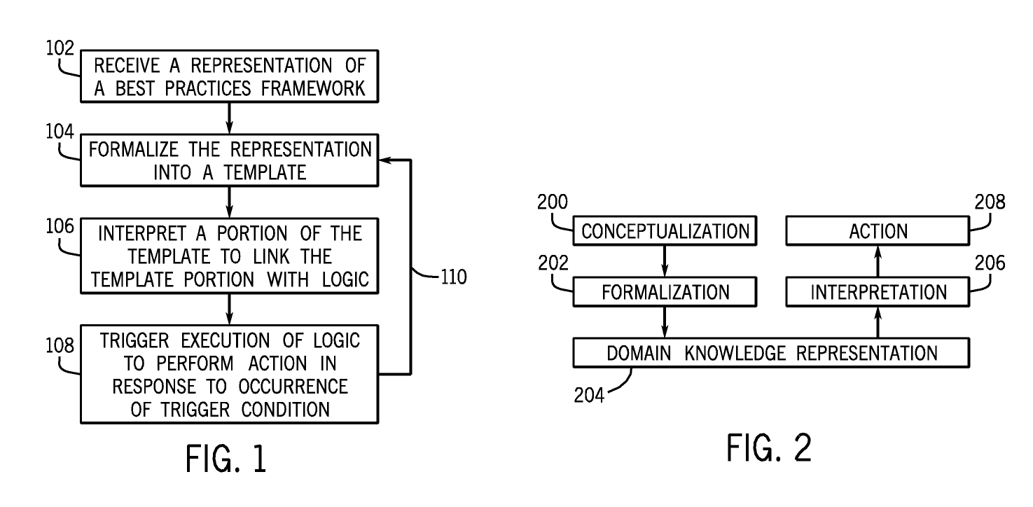

FIG. 1 illustrates a process of a template-based technique to making the best practices framework actionable, according to some embodiments. A representation of a best practices framework is received (at 102). The representation can be in the form of a document (or multiple documents), that describe(s) information relating to best practices associated with a particular domain. Based on the representation, the best practices framework is formalized (at 104) into a machine-readable template. In some implementations, as noted above, the template can be annotated with semantic information to allow the template to be interpreted by the best practices support system according to some implementations. The template can include a set of concepts with their relationships defined. Concepts can be words (or phrases) that are uniquely identified and carry meaning for people. Concepts can further be sub-categorized—for example, an abstract concept can be sub-divided into multiple concrete concepts.

Once the machine-readable template is formed, the best practices support system interprets (at 106) a portion of the template (where “portion” can refer to a subset less than the entirety of the template or to the entirety of the template) to link the portion of the template with logic that corresponds to an action that is to be taken by an individual, or group of individuals, or an organization in relation to the best practices framework. In some implementations, the logic can be in the form of executable code. In this manner, an automated mechanism is provided to define actions that are to be taken in response to corresponding trigger conditions for a best practices framework.

Execution of the logic (that has been linked to the interpreted portion of the template) is triggered (at 108) to perform the action in response to occurrence of a respective trigger condition. According to the foregoing, the best practices support system is able to make processes of a best practices framework actionable, where the processes are dynamic, ad-hoc, and not well-structured. A process is “ad-hoc” if it is possible that the process will be performed in a different way or tasks may be performed in a different order depending upon the project and the people involved. An “ad-hoc” process evolves over time as people perform tasks and, while doing this, create new tasks, based on which the overall process progresses.

As a result of performance of various actions, the template can be updated (as represented by feedback loop 110). Tasks 106 and 108 can then be repeated based on the updated template.

In some examples, a best practices framework can define IT services that are to be provided by an external service provider (external to a particular enterprise). Such an external service provider is considered an outsourcing service provider that is contracted to provide IT services on behalf of the enterprise. Examples of IT services include networking services, email services, or archiving services. Additionally, the services can include business services such as payroll services or accounting services. The best practices framework can thus consider both technical aspects and business aspects relating to provision of IT services by an external service provider. In other examples, the best practices framework can define customer support services.

The following is an example of a fragment of a document that describes a portion of the best practices framework for provision of customer support services. The portion of the best practices framework depicted below is for a customer management process.

In this example, the customer management process includes:

a customer policy

a maintenance of a customer and registration database

customer and registration categorization and risk assessment

customer evaluation and selection

processing of registrations

registration review, renewal and termination

management of customers and customer satisfaction

Implementation of customer service improvement plans

Maintenance of registration

A process description at the abstract level in the example above is relatively general and cannot be implemented directly. Such an abstract process description is first refined and supplemented with more detailed contextual information to arrive at a level of specificity that can actually be implemented to structure and perform work among people. For example, the abstract process description in the example above does not provide detailed guidance on how each of the tasks of the customer management process should be performed.

In accordance with some implementations, the best practices support system is able to enrich the example customer management process above with actionable information, by using a template-based technique as discussed in connection with FIG. 1.

The template-based technique provided by the best practices support system according to some implementations introduces formality as well as flexibility by using templates as opposed to informal text that exist in typical best practices frameworks. Templates offer flexibility while providing the structure that is interpretable by the best practices support system. The template-based technique does not attempt to specify the relatively strict syntactical elements that typically are provided by conventional business process frameworks that focus on machine-executable definitions of processes and their steps. Conventional business process frameworks that attempt to implement best practices frameworks define a finite set of syntactical elements that are to be executed by a process execution engine. However, there is usually some level of difficulty in mapping elements of best practices frameworks into such conventional business process frameworks.

The best practices support system according to some implementations acknowledges that process refinement is to be provided. For example, the set of tasks that are to be performed for a particular process may change from project to project. As a result, a template can be refined to add a task, modify a task, or delete a task. Moreover, a template can be continually refined as people interact during a particular process associated with a best practices framework. As examples, refinement may occur when a task is performed and its status is updated in the template, or when a task is assigned by a manager to a person.

Refinement of a template can be accomplished by providing a pattern that is to be applied on the template. The pattern is interpreted by the best practices support system—for example, the pattern may instruct the best practices support system to drive a dialog with a person to capture further information (entered by a user due to prompting by the dialog), where this further information can be added to the template for refining the template.

As noted above, templates can contain various concepts that can be further sub-categorized into sub-concepts. Table 1 illustrates an example that lists various top-level concepts in the first column and corresponding sub-concepts in the second column. Properties of the respective concepts and sub-concepts are listed in the third column, and a fourth column provides some examples of the respective concepts and sub-concepts.

TABLE 1

| Concept | Sub-concepts | Properties | Examples |
|---|---|---|---|
| Thing | | | customer, |
| (an identifiable | | | registration |
| entity) | | | |
| Context | Relationship, | Lifecycle (plan -> | a business, |
| (identifiable set | Organization, | existence -> | customer |
| of connections | Project | remembrance) | relationship, |
| between things) | | | company, project. |
| Activity | Task (a thing to do), | Lifecycle, spontaneous, | organize a project, |
| (identifiable | Process (planned & sync., | planned, unplanned, | manage a team, |
| motion of | multi-task activity), | synchronized has | prepare a report, |
| something over | Step (atomic unit of | trigger, owner, actor, | provide a dialog. |
| time) | a process), | goal, state, | |
| | Event (notification | Transitions over | |
| | that something happened), | states. | |
| | Conversation | | |
| | (interaction between | | |
| | actors for purpose | | |
| | of information | | |
| | gathering). | | |
| State | Goal (end state of an | Enumeration of | Lifecycle state, |
| (Identifiable | activity), | conditions. | key performance |
| condition of | Lifecycle State | | indicator, desired |
| something at a | (stages over: plan -> | | state. |
| point in time) | existence -> | | |
| | remembrance) | | |
| Item | Document, | Lifecycle. | plan, schedule, |
| (An identifiable | Schedule | | reminder item. |
| thing to work on | | | |
| or work with”) | | | |
| Actor | Person (a human | Lifecycle, has role(s), | Person, Team, |
| (Someone or | being in a role), | activities | Organization, |
| something that | System (system | | Process, |
| carries activity | performing activity) | | Salesforce.com |
| forward). | Service (something or | | |
| | someone doing | | |
| | something for | | |
| | someone else). | | |
| Role | | Lifecycle, | Owner, editor, |
| (function assumed | | Assigned to Actor(s) | creator, manager. |
| by an actor in a | | | |
| context). | | | |

Table 1 above lists a categorization of concepts relating to human activities that are typically found in best practices frameworks. Two examples of the top-level concepts are “thing” and “activity,” which can often be associated with nouns and verbs (or phrases with nouns and verbs) in informal text found in documents associated with best practices frameworks. Other top-level concepts include “context,” “actor,” “role,” and “relationship.” Relationships among concepts lead to graphs, which can be used by the best practices support system as a way of formalizing and representing domain knowledge.

In Table 1, an example of a “thing” includes a customer or a registration. An example of an activity includes “organize a project,” “manage a team,” “prepare a report,” or “provide a dialog.”

General templates regarding a domain can be created centrally by domain experts and then shared with the best practices support system. Such general templates can then be copied later and refined for a particular purpose. As templates are used, they go through a life cycle from general to more refined. As experience is gained within a domain, the refined template can be shared and reused.

FIG. 2 is another flow diagram of a template-based technique to making a best practices framework actionable, according to further embodiments. The process of FIG. 2 can be performed by the best practices support system. Information related to a best practices framework is first conceptualized (at 200). Conceptualization involves identifying information considered to be important. Following conceptualization, formalization is performed (at 202), where the formalization 202 is similar to task 104 in FIG. 1. Formalization causes production of a template, which is also referred to as a “domain knowledge representation” 204 in FIG. 2.

Interpretation (206) can then be applied onto the template, similar to task 106 in FIG. 1. Based on the interpretation and triggered logic, actions can be performed (at 208).

For the example description of the customer management process depicted above, the conceptualization (200) of the customer management process description can result in the following output (where the underlined, bolded, and italicized text correspond to concepts that have been identified by the conceptualization of the best practices support system):

The customer management process should include:

a customer policy

a maintenance of a customer and registration database

customer and registration categorization and risk assessment

customer evaluation and selection

processing of registrations

registration review, renewal and termination

management of customers and customer satisfaction

implementation of customer service improvement plans

maintenance of registrations

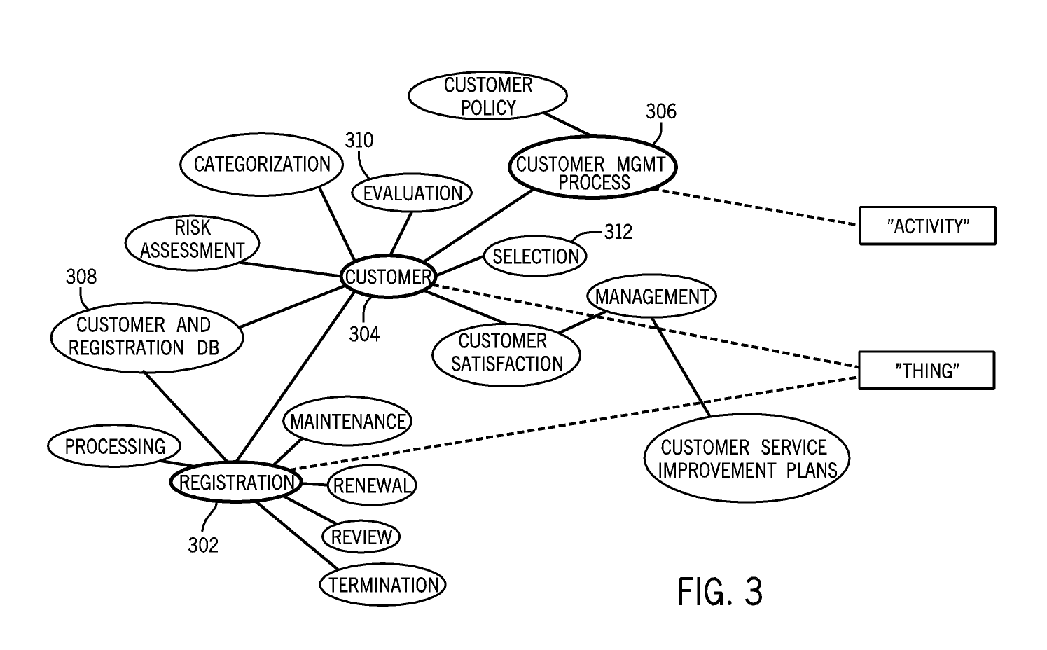

The concepts identified above (associated with words or phrases that are underlined, bolded, and italicized) can be represented as a knowledge graph, as depicted in FIG. 3. A domain expert can decide which of the concepts in the fragment of the customer management process description are to be included in the knowledge graph of FIG. 3. The concepts depicted in FIG. 3 includes a “registration” concept 302, a “customer” concept 304, and a “customer management process” concept 306.

After identifying the concepts, such concepts are mapped to predefined categories that are understood in the best practices support system. For example, the “customer and registration database” concept (308 in FIG. 3) falls into the category of a “thing,” while the customer “evaluation” concept 310 and customer “selection” concept 312 fall in the category of “process.” The mapping of identified concepts to categories can be performed by a domain expert, or can be automatically performed by the best practices support system.

In the FIG. 3 graph, the main concepts of “Customer” and “Registration” are categorized as “things,” while “Customer Management Process” is categorized as an “activity.” The best practices support system is able to generate a dialog that can ask questions about details such as the tasks that are to be provided for a particular concept. Answers to such questions in the dialog can lead to further refinement of the template, such as tasks to be associated, relevant inputs and outputs, relationships with other concepts, and so forth.

In some examples, the top-level concepts that are used by the best practices support system to define templates can be represented using a Resource Description Framework (RDF), as defined by W3C (World Wide Web Consortion).

The templates are to be made actionable to allow the best practices support system to drive activities between people in performing projects. This is achieved by augmenting the concepts in the templates by using interpretation patterns, which are applied to interpret concepts in the templates. While the concepts in a template describe information about a domain, an interpretation pattern describes actions that can be performed on such information.

An interpretation pattern is a defined structure of particular concepts for which actions can be performed by the best practices support system. The actions prescribed in an interpretation pattern (1) may be executed directly by the best practices support system, e.g., by driving a dialog with a user to refine a concept, (2) can lead to actions being performed by other systems (e.g., process engines), and/or (3) can be assigned to an individual (or a group of individuals).

Examples of general interpretation patterns are “refinement,” “creation,” and “execution,” for concepts such as “thing” or “activity.” Top-level concept categories with associated top-level interpretation patterns are built into the best practices support system up-front. As top-level concepts are refined, more concepts with specific interpretation patterns can be added. The notion of an interpretation pattern is a powerful notion for two reasons: (i) the interpretation pattern allows separation of the actionable aspect of the template from the concepts, and (ii) the interpretation pattern enables association of actions to any concept in the template at any level of detail.

As discussed, the processes in best practices frameworks are ad-hoc and may change at runtime depending on the context of projects. To support this dynamicity, refinement interpretation patterns are provided that allow for adding tasks, removing tasks, assignment of tasks, or performing status update of tasks. Refinement interpretation patterns can have a dialog asking questions to individuals to capture further information or update information in the template.

To support the execution of activities and the interactions among people, a set of built-in execution interpretation patterns can be defined for activity-related concepts. In particular, a mapping from activity-related concepts is provided to abstractions in a process definition and execution language. In other words, an execution pattern uses the mapping to generate a process definition for an activity template, and updates it as the template gets refined.

The execution interpretation pattern can cause presentation of a dialog in which individual roles and responsibilities are assigned to the tasks of a process. When actual actions are triggered for assigned roles, individuals behind those roles can receive a notification of actionable items about expected deliverables and time lines as well as the input material the individuals may have to use to perform tasks assigned to them.

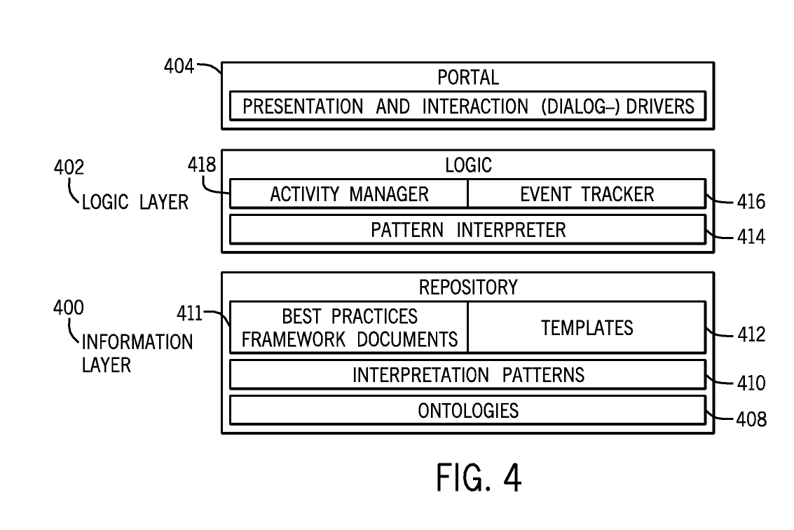

FIG. 4 illustrates the general architecture of a best practices support system according to some examples. The architecture includes three main components: an information repository 400, a logic layer 402, and a portal 404 (where the portal 404 can be a web portal in some examples).

The information repository 400 stores information used by the best practices support system. Such information includes ontologies 406, which define the concepts that are understood by the logic and the interpretation patterns that refer to the ontologies 408. The information repository 400 also includes interpretation patterns 410 as discussed above.

The information repository 400 also stores best practices framework documents 411, which describe best practices framework(s). Templates 412 that have been generated by the best practices support system are also included in the information repository 400.

The logic layer 402 includes a pattern interpreter 414 o load and interpret the interpretation patterns 410. Pattern interpretation is triggered by an event tracker 416 and an activity manager 418. Activities are triggered either as result of user interaction (collaboration) through the user interface portal 404 (e.g., a manager assigns a task to a person), or as the result of some condition becoming true (e.g., the due date for a deliverable has been reached). Events are associated with interpretation patterns, which describe the reaction to the event. The portal 404 allows interactions (collaboration) among individuals in performing a process associated with a best practices framework.

The activity manager 418 is an interface between the best practices support system and other systems, such as process execution engines. The activity manager 418 enables transfer of events captured by the event tracker 416 regarding the progress of an activity to a corresponding process engine, and to return changes in the process execution (e.g., creation of a new task in the workspace of another person) to the portal 404 of the best practices support system.

The portal 404 provides user interfaces to allow for user interaction with the best practices support system. The portal 404 performs at least some of the following general functions: presentation of concepts (information); creation and refinement of templates; initiation of activities; and presentation of information regarding the progress of activities to individuals.

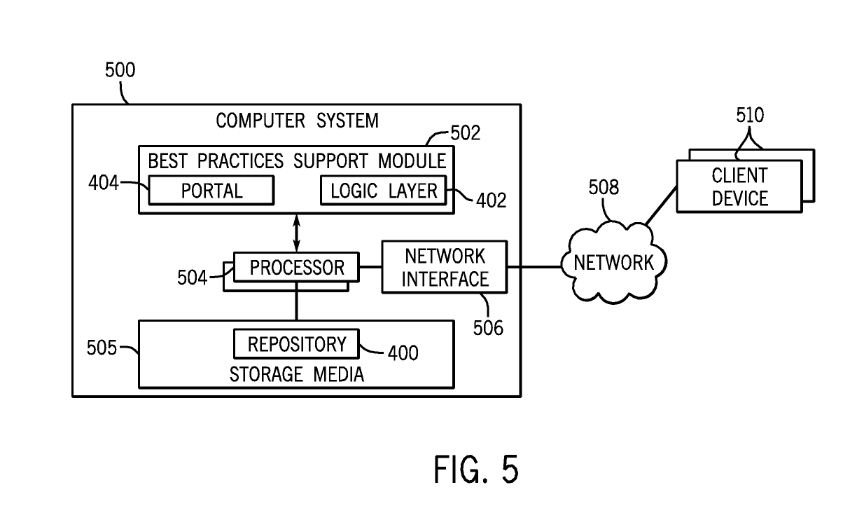

FIG. 5 is a block diagram of an example arrangement that includes a computer system 500 that has a best practices support module 502 configured to perform the various processes discussed above, including those depicted in FIGS. 1 and 2. The best practices support module 502 includes the portal 404 and the logic layer 402, and can be implemented as machine-readable instructions executable on a processor (or multiple processors) 504. The processor(s) 504 is (are) connected to a storage media 505 and a network interface 506. The storage media 505 can store the repository 400 of FIG. 4.

The network interface 506 allows the computer system 500 to communicate over a network 508 with client devices 510, such as desktop computers, notebook computers, personal digital assistants, and so forth.

The computer system 500 can be a single computer node or a distributed arrangement of computer nodes.

The machine-readable Instructions of the module 502 are loaded for execution on a processor (or multiple processors) 504. A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method of a template-based technique for making a best practices framework actionable, comprising:
creating, by a computer system, a formal representation of the best practices framework, wherein the representation includes a machine-readable template;
interpreting, by the computer system, a portion of the template to link the portion of the template with logic that corresponds to an action; and
triggering, by the computer system, execution of the logic to perform the action in response to occurrence of a trigger condition.

2. The method of claim 1, further comprising receiving a document describing the best practices framework at an abstract level.

3. The method of claim 1, wherein the template comprises a construct that is defined as concepts and relationships among the concepts.

4. The method of claim 1, further comprising using the template to drive interactions among individuals in performing tasks associated with a process of the best practices framework.

5. The method of claim 1, further comprising annotating the template with information to allow interpretation of the template to link the interpreted portion of the template with the logic.

6. The method of claim 1, further comprising updating the template based on performance of actions associated with a process of the best practices framework.

7. The method of claim 1, further comprising:
identifying, from the best practices framework, concepts; and
dividing at least one of the concepts into sub-concepts,
wherein the template is based on the concepts and the sub-concepts.

8. The method of claim 1, further comprising refining the template by:
presenting a dialog, by the computer system, to prompt a user to provide further information with respect to the template; and
adding the further information to refine the template.

9. The method of claim 1, wherein interpreting the portion of the template comprises applying an interpretation pattern to one or plural concepts of the portion of the template, wherein the interpretation pattern contains information describing actions to be performed based on information associated with the one or plural concepts.

10. A system comprising:
a storage media to store a repository containing a representation of a best practices framework associated with an ad-hoc process to be performed by people; and
at least one processor to:
identify concepts based on the representation of the best practices framework;
build a template based on the identified concepts;
apply an interpretation pattern to a portion of the template to associate actionable information with the portion of the template; and
upon occurrence of a trigger condition, cause performance of an action specified by the actionable information.

11. The system of claim 10, further comprising:
a portal to present concepts of the best practices framework to a user to allow the user to select a subset of the concepts for use in building the template, wherein the identified concepts include the subset of concepts.

12. The system of claim 11, wherein the portal is to allow interactions among individuals in performing the process associated with the best practices framework.

13. The system of claim 11, wherein the portal is to present a dialog to a user to prompt the user to enter further information regarding the template, and wherein the at least one processor is to refine the template using the further information.

14. The system of claim 10, wherein the repository is to further store an interpretation pattern for application to the template, wherein the interpretation pattern contains information describing actions to be performed based on information associated with the concepts.

15. The system of claim 10, wherein the at least one processor is configured to further:
update the template as tasks associated with the process are performed,
wherein the applying and causing are repeated with the updated template.

16. The system of claim 10, wherein the at least one processor is to further generate a graph having elements corresponding to the concepts, wherein the graph further specifies relationships among the concepts.

17. The system of claim 10, wherein the interpretation pattern specifies at least one of:
an action described by the interpretation pattern is to be performed automatically by the system;
an action described by the interpretation pattern is to be performed by another system; or
an action described by the interpretation pattern is to be assigned to an individual.

18. The system of claim 10, wherein the action performed comprises sending a notification regarding an action item to an individual assigned to perform a task relating to the action.

19. An article comprising at least one computer-readable storage medium storing instructions that upon execution cause a computer system to:
receive a document providing an abstract description of a best practices framework;
identify concepts in the document;
formalize the concepts into a template;
interpret a portion of the template to link the portion of the template with logic that corresponds to a first action;
trigger execution of the logic to perform the first action in response to occurrence of a trigger condition;
in response to performance of tasks associated with the best practices framework, update the template;
interpret a portion of the updated template to link the portion of the updated template with a second action to be performed upon occurrence of a second trigger condition.

20. The article of claim 19, wherein interpreting the portion of the template comprises applying an interpretation pattern that specifies actions to be performed for the best practices framework.
